(19) United States
(12) Patent Application Publication
(10) Pub. No.: US 2010/0163531 A1
(43) Pub. Date: Jul. 1, 2010

(54) METHOD FOR THERMAL WELDING OF JACKET MEMBER OF ENDOSCOPE FLEXIBLE TUBE

(75) Inventors: Kouichi Kamata, Saitama-shi (JP); Atsushi Kanaki, Saitama-shi (JP); Nobuharu Takahashi, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/346,585

(22) Filed: Dec. 30, 2008

(51) Int. Cl. B23K 11/10

(52) U.S. Cl. 219/91.22

(57) ABSTRACT

A flexible tube is placed in large and small furnaces separated by a heat-shield panel, and two kinds of jacket resin of the flexible tube are heated separately at different temperatures for their own softening points. A connecting area of the jacket resin enters the small furnace to a predetermined distance. In this connecting area, the jacket resin fails to reach the softening point temperature, and is not firmly welded to a blade. A cylindrical attachment is used to surround the spot that has lower temperature than the softening point, and hot air of approximately 250° C. is supplied from a spot heater into the cylindrical attachment. The spot in the cylindrical attachment reaches the softening point in a short time, and the jacket resin is welded to the blade.

### FIELD OF THE INVENTION

The present invention relates to a thermal welding method for a jacket member of the endoscope flexible tube which is composed of two kinds of jacket resin having different softening points.

### BACKGROUND OF THE INVENTION

A flexible tube, the component used in an insertion section of an endoscope, is generally produced through a step of winding a metal band into a spiral shape to form a flex (spiral tube), a step of wrapping a blade (net-like tube) around the flex to produce a flexible tube material (tubular component), a step of depositing thermoplastic polymer (hereinafter, thermoplastic resin) on a peripheral surface of the flexible tube material, and a step of thermal welding to heat the flexible tube material at high temperature in a furnace until this outer skin of resin, or jacket resin, is melted to adhere to the blade surface.

Meanwhile, not all the jacket resins are made to have a uniform hardness across a whole length, but some of them have a dual structure which is soft on the front end and relatively hard on the rear end, so as to improve an insertion performance. For example, there is a type of endoscope flexible tube which has a soft front end section as flexible as about 2N-4N and a hard rear end section as flexible as about 7N-10N.

This type of endoscope flexible tube includes two types of thermoplastic resin, the one having a low softening point for the front end section, and the other having a high softening point for the rear end section. A typical softening point of the resin for the front end section is around 170° C., and a typical softening point of the resin for the rear end section is around 188° C. This means that the jacket resin needs to be heated at different temperatures on the front end and the rear end. To facilitate the thermal welding of such multi-stage endoscope flexible tubes, there is disclosed an endoscope tube production apparatus that can separately control multiple temperatures (see, for example, Japanese Patent Laid-open Publication No. 2006-110153).

This production apparatus has a flexible tube heating chamber divided into two or more regions, and several heaters to provide hot air to each region separately. In the heating chamber, the hot air keeps the temperature of the region for the front end section of the endoscope flexible tube to 170° C., and adjusts the temperature of the region for the rear end section to 230° C.

However, this production apparatus does not always achieve good thermal welding, but may lead to poor welding of the jacket resin and the blade, because the jacket resin of the endoscope flexible tube in the 230° C. region does not reach 230° C. in the proximal area to the 170° C.

### SUMMARY OF THE INVENTION

In view of the foregoing, it is an object of the present invention to provide a method for thermal welding of a jacket member of an endoscope flexible tube which provides an excellent thermal welding performance across an entire length of the endoscope flexible tube.

In order to achieve the above and other objects, a method according to the present invention includes a step of surrounding a flexible tube material, a step of heating jacket resin, and a step of applying additional heat. In the surrounding step, the flexible tube material is surrounded with serially connected first and second jacket resin having different softening points. In the heating step, the first jacket resin and the second jacket resin are heated separately at different temperatures for the softening points of their own. In the additional heat step, additional heat is applied from a spot heater to a spot which lies in a connecting area of the first and second jacket resin, and fails to reach said softening points.

In a preferred embodiment of the present invention, in the heating step, the first jacket resin is separated from the second jacket resin by a heat-shield panel. And a position of the heat-shield panel is shifted toward the jacket resin having a higher softening point from a position where the first jacket resin and the second jacket resin are connected.

It is preferred to apply additional heat to one of the first and second jacket resin having a higher softening point.

According to the present invention, because the plural jacket resin having different softening points are separately heated, and then additional heat is applied from the spot heater to the spot of the jacket resin that lies near the connecting position and does not reach the softening point temperature, it is possible to perform the thermal welding across the whole length of the endoscope flexible tube without fail. The present invention allows using plural jacket resin having considerably different softening point temperature, and serves to give the endoscope flexible tube a difference in flexibility between the front end and the rear end thereof. The present invention thereby improves the insertion performance of the endoscope as it is inserted into a tortuous part such as large intestine. In addition, because of the position of the heat-shield panel which is not on the connecting position of the first and second jacket resin, but shifted toward the jacket resin having a higher softening point, it is possible to prevent the jacket resin having a lower softening point from softening more than necessary.

### BRIEF DESCRIPTION OF THE DRAWINGS

The above objects and advantages of the present invention will become more apparent from the following detailed description when read in connection with the accompanying drawings, in which:

FIG. 1 is a flowchart of a thermal welding method for a jacket according to the present invention;

FIG. 2 is a partial cross sectional view illustrating a part of a flexible tube;

FIG. 3 is an explanatory view illustrating the flexible tube in furnaces;

FIG. 4 is an explanatory view illustrating inadequate adhesion between jacket resin and a blade within a certain region;

FIG. 5 is a cross sectional view of the flexible tube with inadequate adhesion between the jacket resin and the blade;

FIG. 6 is a perspective view of the flexible tube and a spot heater during additional heating; and

FIG. 7 is a cross sectional view of the flexible tube and a cylindrical member during additional heating.

### DETAILED DESCRIPTION OF THE PREFERRED EMBODIMENTS

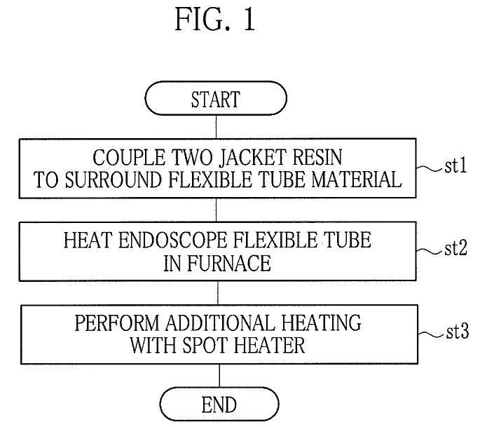

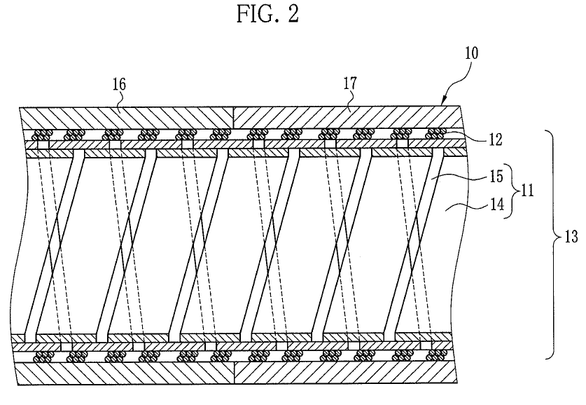

Referring to FIG. 1, a thermal welding method for a jacket of the endoscope flexible tube according to the present invention includes the step of surrounding a flexible tube material 13 (see, FIG. 2) with serially connected two kinds of jacket resin having different softening points (st1), the step of heating them in furnaces to thermally weld the jacket resin (st2), and the step of applying additional heat from a spot heater to a spot of the jacket resin that is poorly welded due to failure to reach the softening point (st3).

As shown in FIG. 2, a long and thin endoscope flexible tube (hereinafter, flexible tube) 10 has a flexible tube material (tubular component) 13 composed of a flex (spiral tube) 11 and a blade (a net-like element) 12 around the flex 11. The flex 11 has a dual structure consisted of a first flex 14 and a second flex 15 wrapped around the first flex 14.

On a peripheral surface of the flexible tube material 13, a jacket tube of thermoplastic resin is formed by extrusion molding. This jacket tube has a dual structure composed of two kinds of resin (hereinafter, jacket resin) 16, 17. In this embodiment, the jacket resin 16 has a softening point at a temperature a of 170° C., and the jacket resin 17 has a softening point at a temperature P of 188° C. Exemplary materials for the jacket resins 16, 17 are PANDEX T-8180 and PANDEX T-8195 (both product names), the thermoplastic polyurethane elastomer from DIC Bayer Polymer Ltd.

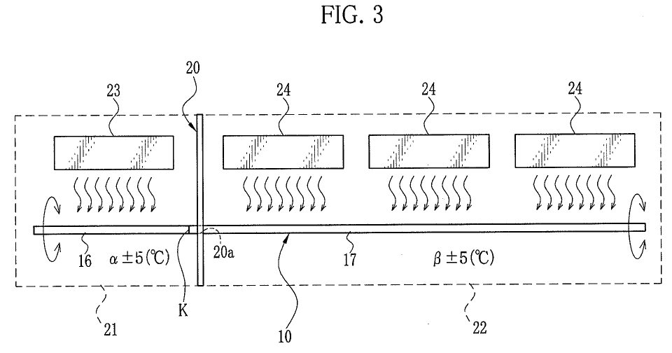

As shown in FIG. 3, the jacket resin 16, 17 are joined without a gap at a border line (connecting position) K (st1). The jacket resin 16 in the front end occupies nearly one quarter of the total length of the flexible tube 10, and the jacket resin 17 in the rear end occupies the remaining three quarters of the total length.

The flexible tube 10 is placed in two, small and large furnaces 21, 22 that are separated from each other by a ceramic heat-shield panel 20. The flexible tube 10 is inserted into an aperture 20a that pierces the heat-shield panel 20, so that the jacket resin 16 is located in the small furnace 21 and the jacket resin 17 is located in the large furnace 22, and that the boarder line K enters the small furnace 21 slightly beyond the heat-shield panel 20.

The small furnace 21 has a heater 23, and the large furnace 22 has more, for example three, heaters 24. In the small furnace 21, the heater 23 blows hot air on the jacket resin 16 to keep the temperature of the jacket resin 16 at ±5° C. from the temperature α (170° C.). In the large furnace 22, each heater 24 blows hot air on the jacket resin 17 to keep (st2) the temperature of the jacket resin 17 at ±5° C. from the temperature β (188° C.).

During this process, the flexible tube 10 is kept rotated around the axis thereof so as to deliver the hot air evenly on all sides of the flexible tube 10. It is also possible, instead of rotating the flexible tube 10, to rotate the heaters 23, 24 around the flexible tube 10.

Because of the position of the border line K which, as mentioned, is shifted to the inside of the small furnace 21 from the heat-shield panel 20, the temperature of the jacket resin 16 near the heat-shield panel 20 is unaffected by the temperature of the large furnace 22 that will raise the temperature of the jacket resin 16 excessively higher than the softening point α. As a result, the jacket resin 16 is prevented from softening more than necessary.

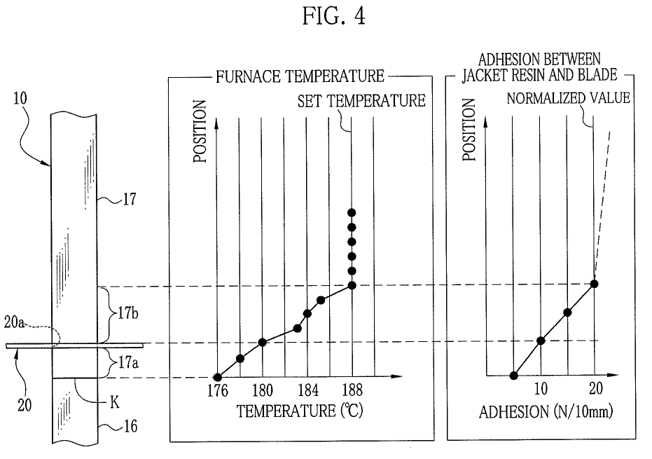

As shown in FIG. 4, in the small furnace 21, the temperature of a spot 17a of the jacket resin 17 that stretches from the border line K to the heat-shield panel 20 becomes higher than the temperature α (170° C.) as the spot 17a comes closer to the heat-shield panel 20, due to the temperature β of the large furnace 22. By contrast, in the large furnace 22, the temperature of a spot 17b of the jacket resin 17 that lies next to the heat-shield panel 20 becomes lower than the temperature β (188° C.) as the spot 17b comes closer to the heat-shield panel 20, due to the temperature a of the small furnace 21.

The reason of this, the influence of the furnaces on the spots 17a, 17b in the other furnaces, is that the heat-shield panel 20 is made as thin as possible to minimize unheatable spots, and that the heat-shield panel 20 has the aperture 20a to receive the flexible tube 10.

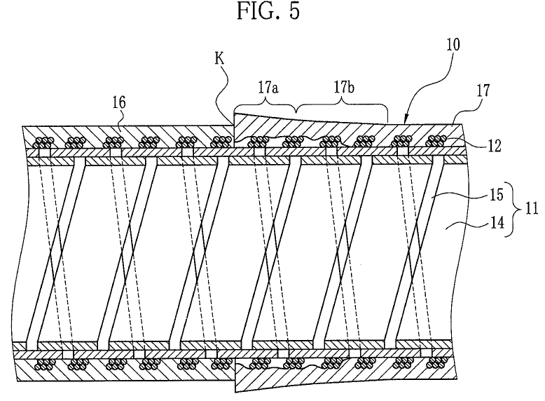

Therefore, in the spots 17a, 17b, the jacket resin 17 is not melted sufficiently, and the adhesion between the jacket resin 17 and the blade 12 decreases from a predetermined value 20 (N/10 mm) in the vicinity of the heat-shield panel 20. This phenomenon results in poor welding, as shown in FIG. 5, of the jacket resin 17 and the blade 12 in the spots 17a, 17b near the border line K, and the jacket resin 17 sits suspended on the blade 12.

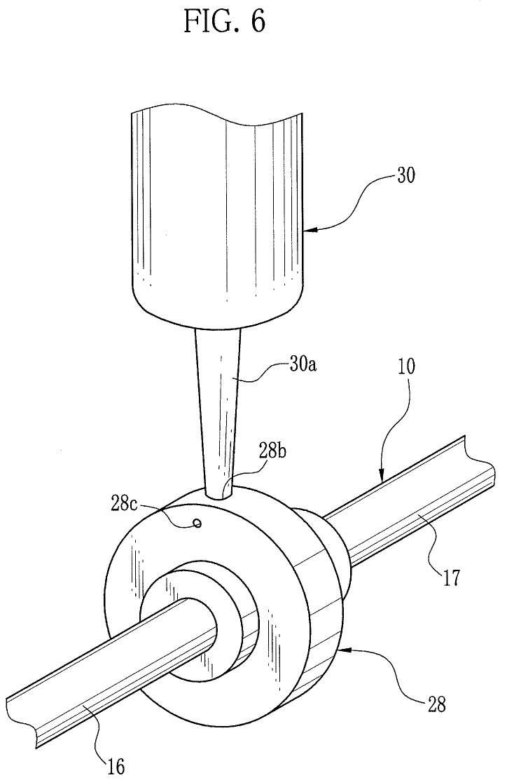

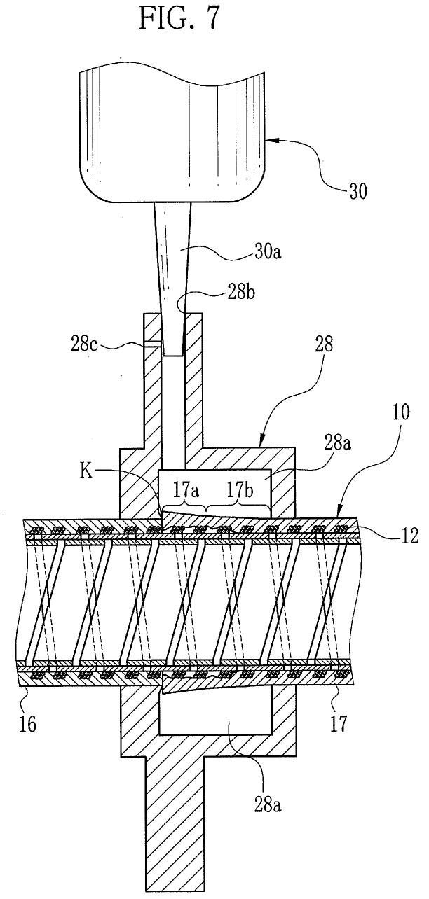

To address this drawback, a doughnut-shaped cylindrical attachment 28 with an interior chamber 28a, as shown in FIG. 6 and FIG. 7, is attached on the flexible tube 10 to surround the spots 17a, 17b, and a spot heater 30 is connected through a nozzle 30a that is inserted in an opening 28b on a peripheral surface of the cylindrical attachment 28. One of the side walls of the cylindrical attachment 28 has an air vent hole 28c to release air as the nozzle 30a is inserted or removed.

By way of the nozzle 30a, hot air at sufficient temperature, such as 250° C., is supplied from the spot heater 30 to the chamber 28a of the cylindrical attachment 28. This additional heating to the spots 17a, 17b of the jacket resin 17 (st3) raises the temperature of the spots 17a, 17b to the softening point temperature β (188° C.) in a short time, and the jacket resin 17 in the spots 17a, 17b is melted and welded to the blade 12.

In this manner, with the additional heating, the thermal welding of the jacket resin is completed without fail across the whole length of the flexible tube, even when the jacket tube is composed of two kinds of jacket resin having greatly different softening points. It is therefore possible to give the flexible tube a great difference in flexibility between the front end and the rear end, and to improve an insertion performance of the endoscope as it is inserted into large intestine or such a tortuous part.

Although the thermal welding method in the above embodiment is directed to the jacket member (or jacket tube) of the endoscope flexible tube that has two kinds of serially connected jacket resin having different softening points, the present invention is applicable to the jacket tube composed of three kinds of jacket resin having different softening points, and still achieves the same effect.

The jacket resin in the above embodiment is mere example, and insofar as they have different softening points, any thermoplastic resin can be used.

While the ceramic heat-shield panel is used to separate the furnaces in the above embodiment, the heat-shield panel may be made of any material that blocks heat to some extent.

Although the present invention has been fully described by the way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A method for thermal welding of a jacket member of an endoscope flexible tube comprising steps of:
surrounding a flexible tube material with serially connected first and second jacket resin having different softening points;
heating said first and second jacket resin separately at different temperatures for said softening points of their own; and
applying additional heat from a spot heater to a spot which lies in a connecting area of said first jacket resin and said second jacket resin and fails to reach said softening points.

2. The method for thermal welding defined in claim 1, wherein in said heating step said first jacket resin is separated from said second jacket resin by a heat-shield panel, and a position of said heat-shield panel is shifted toward the jacket resin having a higher softening point from a position where said first jacket resin and said second jacket resin are connected.

3. The method for thermal welding defined in claim 1, wherein said additional heat is applied to one of said first and second jacket resin having a higher softening point.
